(19) United States
(12) Patent Application Publication
(10) Pub. No.: US 2020/0304692 A1
(43) Pub. Date: Sep. 24, 2020

(54) LENS MODULE AND ELECTRONIC DEVICE USING THE LENS MODULE

(71) Applicant: TRIPLE WIN TECHNOLOGY(SHENZHEN) CO.LTD., Shenzhen (CN)

(72) Inventors: SHUAI-PENG LI, Shenzhen (CN); KUN LI, Shenzhen (CN); LONG-FEI ZHANG, Shenzhen (CN); SHIN-WEN CHEN, Tu-Cheng (TW)

(21) Appl. No.: 16/410,061

(22) Filed: May 13, 2019

(30) Foreign Application Priority Data
Mar. 21, 2019 (CN) 201910219368.X

(51) Int. Cl. H04N 5/225

(52) U.S. Cl. CPC H04N 5/2254; H04N 5/2253

(57) ABSTRACT

A lens module capable of simpler and more efficient manufacture includes a circuit board, a photosensitive chip fixed on the circuit board, a plurality of electronic components, and metal wires mounted on the circuit board. A light-absorbing first adhesive layer is applied to the circuit board, a lens module is fixed to the first adhesive layer, and a filter is installed to face the photosensitive ship. The first adhesive layer envelops the electronic components and the metal wires. An electronic device applying such a lens module is also provided.

### FIELD

The subject matter herein generally relates to imaging devices.

### BACKGROUND

The lens module is a core component of a camera device. The lens module has evolved to be smaller in volume and higher in performance. However, the lens module produced by a conventional process may be low in cost but large in size. On the other hand, the lens modules produced with advanced devices has a high cost and a low yield.

Therefore, there is room for improvement.

### BRIEF DESCRIPTION OF THE DRAWINGS

Implementations of the present technology will now be described, by way of embodiments, with reference to the attached figures.

FIG. 1 is an isometric view of a lens module according to an embodiment of the present disclosure.

FIG. 2 is an exploded view of the lens module of FIG. 1.

FIG. 3 is an isometric view of a lens unit of the lens module of FIG. 1.

FIG. 4 is a cross-sectional view taken along line VIII-VIII of FIG. 1.

FIG. 5 is an isometric view of a lens module according to another embodiment of the present disclosure.

FIG. 6 is an exploded view of the lens module of FIG. 5.

FIG. 7 is an isometric view of a lens unit of the lens module of FIG. 5.

FIG. 8 is a cross-sectional view taken along line IV-IV of FIG. 5.

FIG. 9 is a perspective view of an electronic device with the lens module of FIG. 1 or 5 installed thereon.

### DETAILED DESCRIPTION

The present disclosure is made in conjunction with the accompanying drawings. Specific embodiments of the present disclosure are described.

In the following description, when an element is described as being “fixed to” another element, the element can be fixed to the another element with or without intermediate elements. When an element is described as “connecting” another element, the element can be connected to the other element with or without intermediate elements.

Without a given definition otherwise, all terms used have the same meaning as commonly understood by those skilled in the art. The term “and/or” means including any and all combinations of one or more of associated listed items.

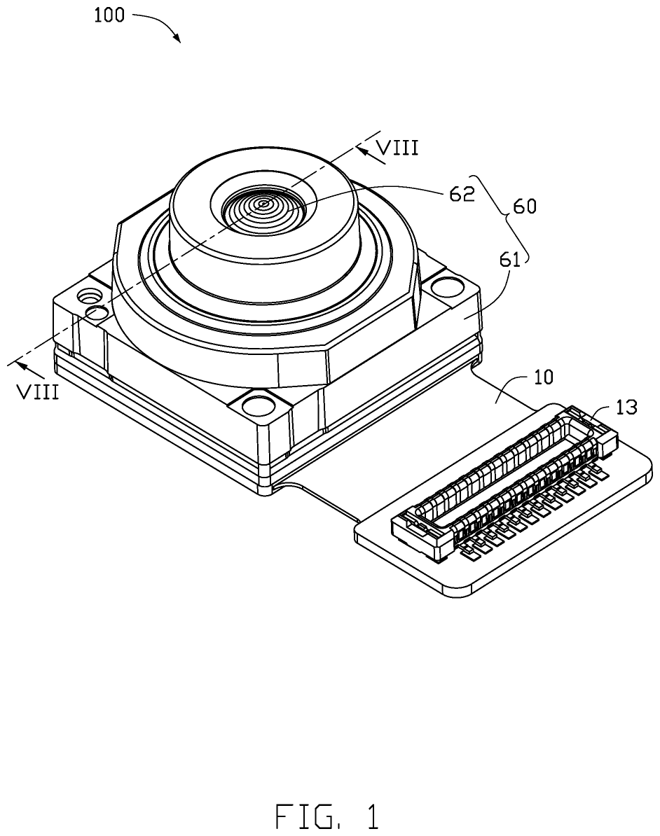

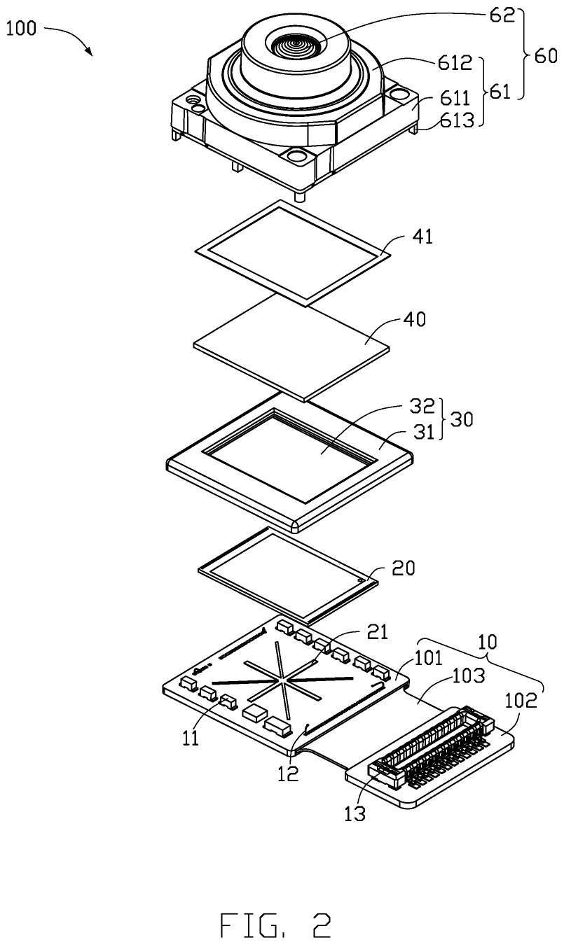

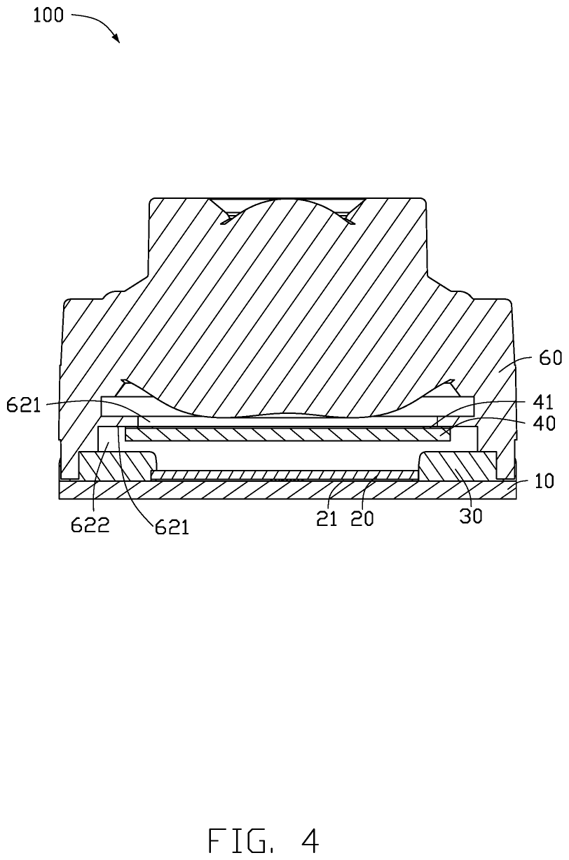

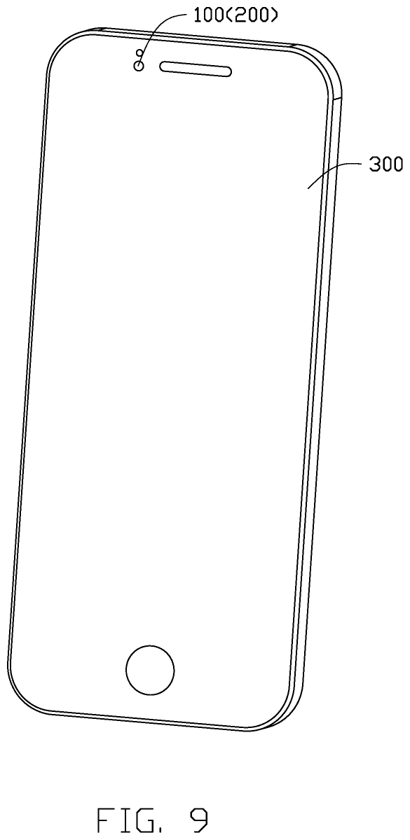

Referring to FIG. 1 to FIG. 4, an embodiment of the present disclosure provides a lens module 100 for use in an electronic device. The electronic device can be a smart phone, a tablet computer, or the like. In this embodiment, the electronic device is a mobile phone 300 (see FIG. 9). The lens module 100 includes a circuit board 10, a photosensitive chip 20, a first adhesive layer 30, a filter 40, and a lens unit 60.

The circuit board 10 can be a ceramic substrate, a soft board, a hard board, or a board combining soft and hard. In the embodiment, the circuit board 10 is a soft and hard board, and includes a first hard board portion 101, a second hard board portion 102, and a soft board portion connected between portions 101 and 102. A photosensitive chip 20, a plurality of electronic components 11, and a plurality of metal wires 12 are mounted on a surface of the first hard board portion 101. The electronic components 11 and the metal wires 12 surround the photosensitive chip 20. The metal wires 12 are electrically connected to the photosensitive chip 20.

The first adhesive layer 30 is disposed on the surface of the first hard board portion 101 where the photosensitive chip 20 is located. The photosensitive chip 20 is fixed to the first hard board portion 101 by a second adhesive layer 21. The second adhesive layer 21 can be an optical adhesive. In the embodiment, the photosensitive chip 20 is a complementary metal oxide semiconductor (CMOS) chip or a charge coupled device (CCD) chip and is rectangular in shape. The metal wires 12 may be made of a metal having a high electrical conductivity, such as gold. The electronic components 11 can include passive components such as resistors, capacitors, diodes, transistors, relays, and electrically erasable programmable read only memorys (EEPROMs).

An electrical connection element 13 is mounted on the second hard board portion 102. The electrical connection element 13 transmits signals between the lens module 100 and other components of the electronic device. The electrical connection element 13 can be a connector or a gold fingers. In the embodiment, the electrical connection portion 13 is a connector.

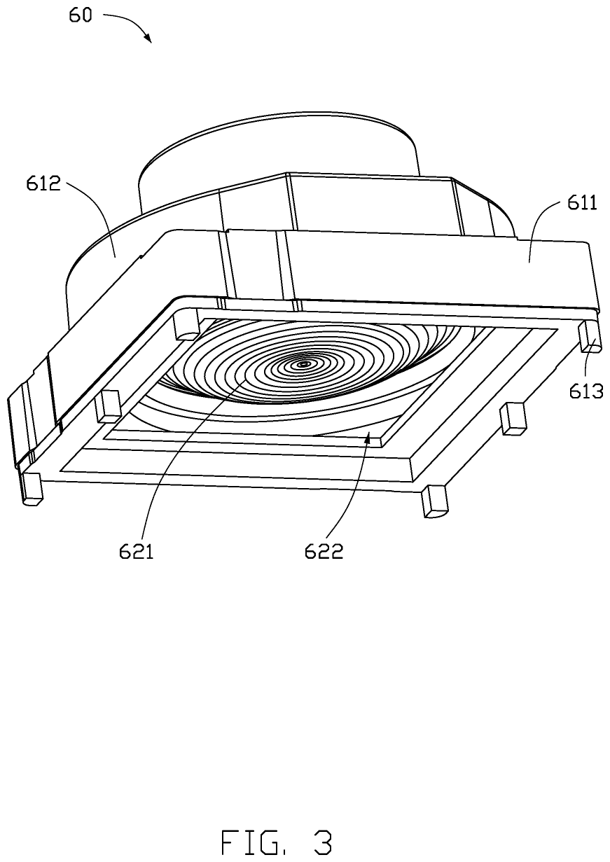

The first adhesive layer 30 is fixed on the first hard board portion 101. The first adhesive layer 30 is shape of a rectangular frame, and includes a main body 31 and a through hole 32 defined on the main body 31. Referring to FIG. 3, in the embodiment, the photosensitive chip 20 is located in the through hole 32. The main body 31 surrounds the photosensitive chip 20 and covers the electronic components 11 and the metal wires 12. The main body 31 does not extend beyond the outer periphery of the first hard board portion 101.

For producing such a lens module 100, no special molding device is required, only a glue spreading machine is needed to produce the first adhesive layer 30 on the first hard board portion 101. Glue from the glue spreading machine is restricted from going beyond the periphery of the first hard board portion 101, so that the first adhesive layer 30 does not go over the outer periphery of the first hard board portion 101. At the same time, an image area of the photosensitive chip 20 is shielded to prevent the image area from being contaminated by the glue. In the embodiment, the first adhesive layer 30 can be a thermosetting adhesive or a UV adhesive. The amount of the glue and the path of the glue spreading machine are predetermined to avoid the image area of the photosensitive chip 20, while covering the electronic components 11, the metal wires 12, and the periphery of the photosensitive chip 20. The glue spread on the first hard board portion 101 when solid forms the first adhesive layer 30. The first adhesive layer 30 is not easily cracked and deformed, and is less affected by temperature and humidity. The first adhesive layer 30 is also opaque and light-proof, thereby improving the reliability of the lens module 100.

In the embodiment, the first adhesive layer 30 envelops the electronic components 11 and the metal wires 12, and reduces the distances from the electronic components 11 to the edges of the first hard board portion 101, thereby miniaturizing the lens module 100.

In a conventional lens module, a small amount of light will reach the metal wire 12 when light is irradiated into the conventional lens module at a specific angle. The metal wire 12 reflects light and causes flashing and ghost imaging on the photosensitive chip 20. In the lens module 100, the first adhesive layer 30 envelops the metal wire 12. The first adhesive layer 30 absorbs any light falling thereon and reduces flashing caused by the metal wire 12 reflecting light onto the photosensitive chip 20.

The glue is effectively prevented from contaminating the image area of the photosensitive chip 20, by adjusting the amount of the glue applied and the path of the glue spreading machine, thereby improving a yield of the lens module 100.

In the embodiment, the lens unit 60 is directly bonded to the first hard board portion 101 after the glue is spread on the first hard board portion 101. The lens unit 60 includes a lens holder 61 and a lens 62 formed in the lens holder 61. The lens holder 61 and the lens 62 can be made of a resin. In the embodiment, the lens holder 61 can be integrally formed with the lens 62 by an injection molding process.

In the embodiment, the lens holder 61 is fixed to a surface of the first adhesive layer 30 away from the circuit board 10. The lens holder 61 includes a substantially square first holder portion 611, a substantially cylindrical second holder portion 612, and a plurality of posts 613 extended downwardly from the first holder portion 611. The posts 613 are fixed to the first adhesive layer 30. In the embodiment, there are six posts 613. In other embodiments, the number of the posts 613 can be less or greater than six. The second holder portion 612 is connected to the first holder portion 611 away from the circuit board 10. A width of the first holder portion 611 is greater than a width of the second holder portion 612.

The second holder portion 612 is opened at a side away from the first lens holder portion 611, to expose the lens 62. A spacer 621 is formed below the lens 62. The spacer 621 and the first holder portion 611 cooperatively form an accommodating space (hereinafter “the first accommodating space 622”). The filter 40 is received in the first accommodating space 622 to face the photosensitive chip 20.

In the embodiment, a third adhesive layer 41 is disposed around an edge region of the filter 40. The third adhesive layer 41 is also frame-shaped and is square, and the third adhesive layer 41 bonds the filter 40 to the spacer 621. The third adhesive layer 41 can be an optical glue.

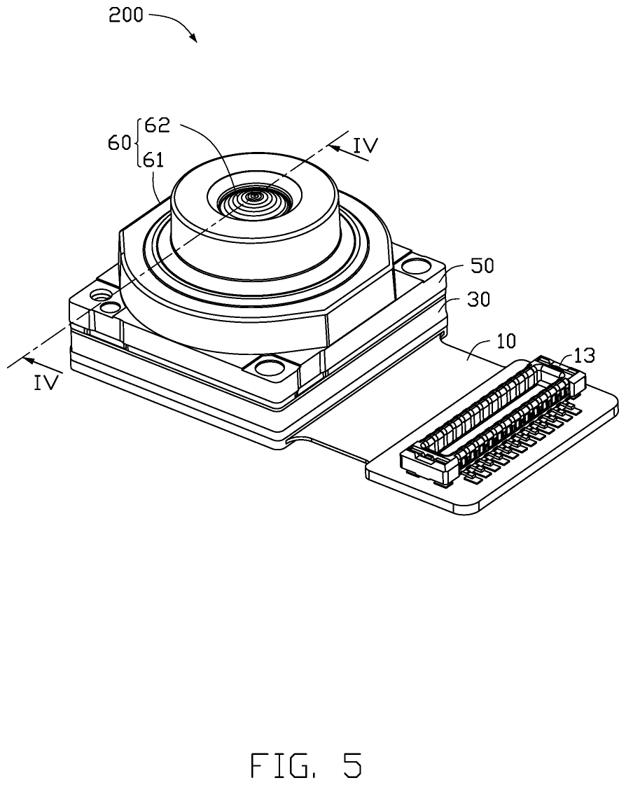

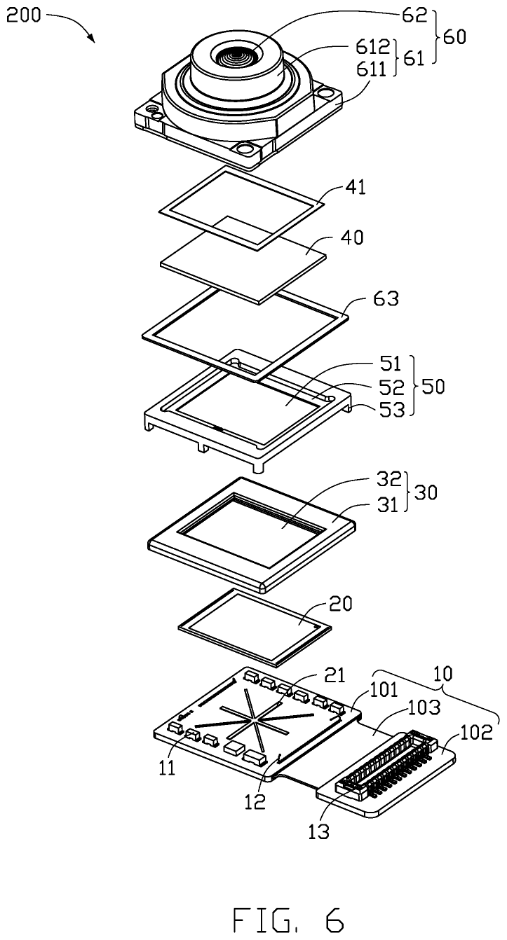

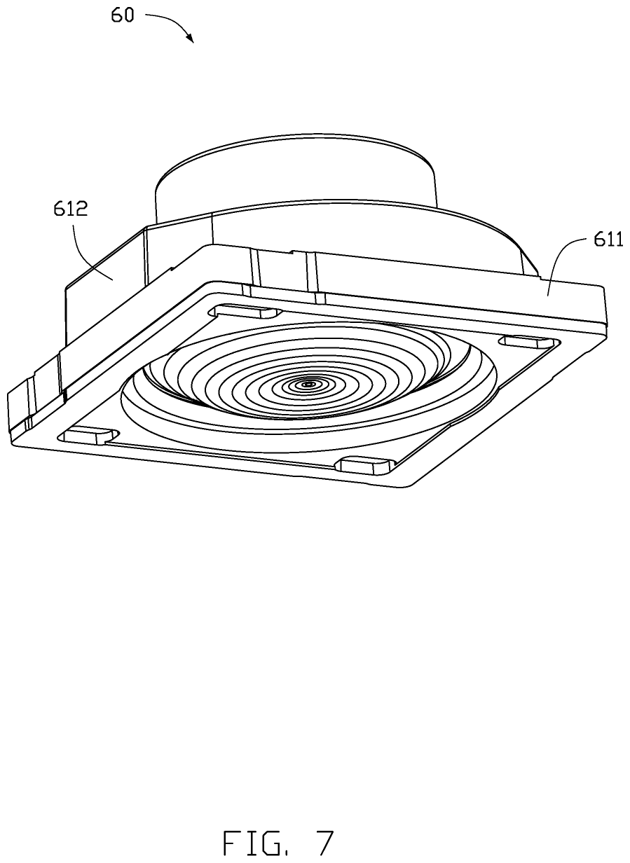

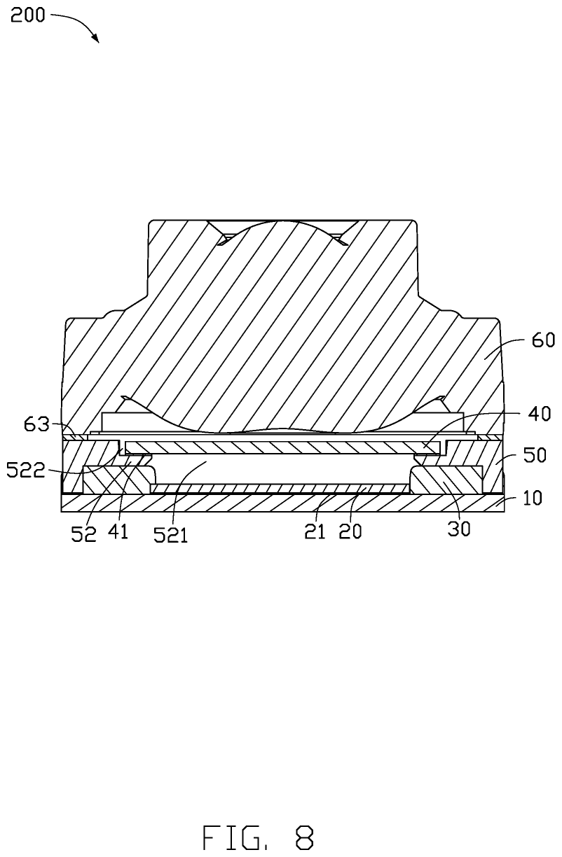

FIG. 5 to FIG. 8 show a lens module 200 according to a second embodiment. The lens module 200 is the same as the lens module 100 in structure excepting that the lens module 200 includes a bracket 50. The bracket 50 is fixed on the first adhesive layer 30. The lens unit 60 is fixed on the bracket 50 away from the circuit board 10, and the filter 40 is also fixed on the bracket 50.

In the embodiment, the bracket 50 includes six supporting posts 53 that are fixed on the first adhesive layer 30. In other embodiments, the number of the supporting posts 53 can be less or more than six. Each supporting post 53 is configured to fix a position of the bracket 50 on the first adhesive layer 30 and prevent the glue from collapsing during solidification.

A through hole 51 is defined in the middle of the bracket 50. An inner wall of the through hole 51 extends toward the central axis of the through hole 51 to form a flange 52. The flange 52 divides the through hole 51 into two accommodating spaces (hereinafter referred as “second accommodating space 521” and “third accommodating space 522”). The second accommodating space 521 is adjacent to the circuit board 10 and the third accommodating space 522 is away from the circuit board 10. The photosensitive chip 20 is received in the second accommodating space 521. The filter 40 is fixed to the flange 52 through the third adhesive layer 41 and is received in the third accommodating space 522. The filter 40 faces the photosensitive chip 20.

The lens module 200 includes a fourth adhesive layer 63. The fourth adhesive layer 63 is also frame-shaped. The body of the fourth adhesive layer 63 is disposed on an edge region of the bracket 50 away from the circuit board 10. The first holder portion 611 of the lens unit 60 is fixed to the bracket 50 by the fourth adhesive layer 63. The fourth adhesive layer 63 can be an optical glue.

In the embodiment, no post extends downwardly from the first lens holder portion 611.

Referring to FIG. 9, the lens modules 100 and 200 can be applied in various electronic devices equipped with camera modules, such electronic devices include mobile phones, wearable devices, computer devices, vehicles, and monitoring devices. In the embodiment, the lens modules 100 and 200 are applied in a mobile phone 300.

The lens module provided by the present disclosure has the following beneficial effects. First, the first adhesive layer is formed by directly spreading glue on the first hard board portion of the circuit board so as to envelop the electronic components, thereby reducing the distances from the electronic components 11 to edges of the first hard board portion 101, and also miniaturizing the lens module. Second, the first adhesive layer envelops the metal wires, thereby preventing light on the metal wires causing flashing and thus improving image quality. Third, forming the first adhesive layer on the first hard board portion does not require special molding equipment and molds, only a glue spreading machine. This reduces the cost. Fourth, in the first embodiment, the lens unit is directly bonded to the circuit board after the glue is spread, no step of covering the circuit board is needed, thereby saving work and improving efficiency. Fifth, adjusting the amount of glue and the path of the glue spreading machine prevents the glue from contaminating the image area of the photosensitive chip, thereby improving the yield.

The embodiments shown and described above are only examples. Even though numerous characteristics and advantages of the present technology have been set forth in the foregoing description, together with details of the structure and function of the present disclosure, the disclosure is illustrative only, and changes can be made in the detail, including in matters of shape, size, and arrangement of the parts within the principles of the present disclosure, up to and including the full extent established by the broad general meaning of the terms used in the claims.

What is claimed is:

1. A lens module comprising a circuit board, a photosensitive chip fixed on the circuit board, a plurality of electronic components and metal wires mounted on the circuit board, a first adhesive layer adhesive to the circuit board, a lens module fixed to the first adhesive layer, and a filter facing the photosensitive ship, wherein the first adhesive layer envelops the electronic components and the metal wires.

2. The lens module as claimed in claim 1, wherein the first adhesive layer comprises a main body and a through hole defined on the main body, the main body envelops the electronic components and the metal wires, and the photosensitive chip is located in the through hole.

3. The lens module as claimed in claim 1, wherein the circuit board comprises a first hard board portion, a second hard board portion and a soft board portion connecting between the first hard board portion and the second hard board portion, the electronic components, the metal wires and the photosensitive chip are mounted on the first hard board portion and surrounds the photosensitive chip, the metal wires are electrically connected to the photosensitive chip.

4. The lens module as claimed in claim 3, further comprising an electronic connection element mounted on the second hard board portion for transmitting signals between the lens module and external.

5. The lens module as claimed in claim 3, further comprising a second adhesive layer fixing the photosensitive chip to the first hard board portion.

6. The lens module as claimed in claim 1, wherein the lens unit comprises a lens holder and a lens received in the lens holder, a spacer is formed below the lens, the spacer and the lens holder cooperatively form an first accommodating space for receiving the filter, the filter is adhesive to the spacer by an adhesive layer.

7. The lens module as claimed in claim 1, further comprising a bracket fixing the lens unit and the filter to the first adhesive layer.

8. The lens module as claimed in claim 7, wherein a through hole is defined in the bracket, a flange is formed on an inner wall of the through hole and separates the through hole to a second accommodating space and a third accommodating space, the second accommodating space is adjacent to the circuit board and the third accommodating space is away from the circuit board, the photosensitive chip is received in the second accommodating space.

9. The lens module as claimed in claim 8, wherein the filter is adhesive to the flange by an adhesive layer and received in the third accommodating space.

10. The lens module as claimed in claim 7, wherein the lens unit is adhesive to the bracket by an adhesive layer.

11. An electronic device comprising a lens module, the lens module comprising a circuit board, a photosensitive chip fixed on the circuit board, a plurality of electronic components and metal wires mounted on the circuit board, a first adhesive layer adhesive to the circuit board, a lens module fixed to the first adhesive layer, and a filter facing the photosensitive ship, wherein the first adhesive layer envelops the electronic components and the metal wires.

12. The electronic device as claimed in claim 11, wherein the first adhesive layer comprises a main body and a through hole defined on the main body, the main body envelops the electronic components and the metal wires, and the photosensitive chip is located in the through hole.

13. The electronic device claimed in claim 11, wherein the circuit board comprises a first hard board portion, a second hard board portion and a soft board portion connecting between the first hard board portion and the second hard board portion, the electronic components, the metal wires and the photosensitive chip are mounted on the first hard board portion and surrounds the photosensitive chip, the metal wires are electrically connected to the photosensitive chip.

14. The electronic device as claimed in claim 13, further comprising an electronic connection element mounted on the second hard board portion for transmitting signals between the lens module and other components of the electronic device.

15. The electronic device as claimed in claim 13, further comprising a second adhesive layer fixing the photosensitive chip to the first hard board portion.

16. The electronic device as claimed in claim 11, wherein the lens unit comprises a lens holder and a lens received in the lens holder, a spacer is formed below the lens, the spacer and the lens holder cooperatively form an first accommodating space for receiving the filter, the filter is adhesive to the spacer by an adhesive layer.

17. The electronic device as claimed in claim 11, further comprising a bracket fixing the lens unit and the filter to the first adhesive layer.

18. The electronic device as claimed in claim 17, wherein a through hole is defined in the bracket, a flange is formed on an inner wall of the through hole and separates the through hole to a second accommodating space and a third accommodating space, the second accommodating space is adjacent to the circuit board and the third accommodating space is away from the circuit board, the photosensitive chip is received in the second accommodating space.

19. The electronic device as claimed in claim 18, wherein the filter is adhesive to the flange by an adhesive layer and received in the third accommodating space.

20. The electronic device as claimed in claim 17, wherein the lens unit is adhesive to the bracket by an adhesive layer.
